(19) United States
(12) Patent Application Publication
(10) Pub. No.: US 2010/0078483 A1
(43) Pub. Date: Apr. 1, 2010

(54) Arrangement for and method of generating uniform distributed line pattern for imaging reader

(76) Inventors: Rong Liu, Selden, NY (US); David Tsi-Shi, Stony Brook, NY (US); Ming Yu, South Setauket, NY (US)

Correspondence Address: Kirschstein, Israel, Schiffmiller & Pieroni, P.C., 425 FIFTH AVENUE, 5TH FLOOR, NEW YORK, NY, 10016-2223, US

(21) Appl. No.: 12/286,087

(22) Filed: Sep. 26, 2008

(51) Int. Cl. G06K 7/10

(52) U.S. Cl. 235/462.42

(57) ABSTRACT

A module and an arrangement for, as well as a method of, generating a generally uniform distributed line pattern of light on a symbol to be read by image capture employs a light source for generating light along an optical axis in a distribution having different extents along intersecting directions generally perpendicular to the axis, a linear lens array having a plurality of compound curvature lenses spaced apart from one another along one of said directions, for receiving the light from the light source, and for optically modifying the light from the light source to generate the generally uniform distributed line pattern of light on the symbol, each lens having a concave curvature for diverging the light along said one direction, and a convex curvature for collimating the light along the other of said directions, and a solid-state imager having an array of image sensors for capturing return light from the symbol over a field of view having different extents along the intersecting directions.

### DESCRIPTION OF THE RELATED ART

Solid-state imaging systems or imaging readers, as well as moving laser beam readers or laser scanners, have both been used to electro-optically read targets, such as one-dimensional bar code symbols, particularly of the Universal Product Code (UPC) type, each having a row of bars and spaces spaced apart along one direction, as well as two-dimensional symbols, such as Code 49, which introduced the concept of vertically stacking a plurality of rows of bar and space patterns in a single symbol. The structure of Code 49 is described in U.S. Pat. No. 4,794,239. Another two-dimensional code structure for increasing the amount of data that can be represented or stored on a given amount of surface area is known as PDF417 and is described in U.S. Pat. No. 5,304,786.

The imaging reader includes an imaging module having a solid-state imager with a sensor array of cells or photosensors, which correspond to image elements or pixels in a field of view of the imager, and an imaging lens assembly for capturing return light scattered and/or reflected from the symbol being imaged, and for projecting the return light onto the sensor array to initiate capture of an image of the symbol. Such an imager may include a one- or two-dimensional charge coupled device (CCD) or a complementary metal oxide semiconductor (CMOS) device and associated circuits for producing and processing electronic signals corresponding to a one- or two-dimensional array of pixel information over the field of view.

It is therefore known to use the imager for capturing a monochrome image of the symbol as, for example, disclosed in U.S. Pat. No. 5,703,349. It is also known to use the imager with multiple buried channels for capturing a full color image of the symbol as, for example, disclosed in U.S. Pat. No. 4,613,895. It is common to provide a two-dimensional CCD with a 640×480 resolution commonly found in VGA monitors, although other resolution sizes are possible.

In order to increase the amount of the return light captured by the imager, especially in dimly lit environments and/or at far range reading, the imaging module generally also includes an illuminating light assembly for illuminating the symbol with illumination light for reflection and scattering therefrom. When the imager is one-dimensional, i.e., linear, or is two-dimensional with an anamorphic field of view, the illumination light preferably is distributed along a short height, distributed pattern, also termed an illuminating or scan line, that extends lengthwise along the symbol. The distributed line pattern is typically generated by using a single, large light source, e.g., a light emitting diode (LED) sized in the millimeter range, and a single cylindrical lens.

Although generally satisfactory for its intended purpose, the use of the single large LED and the single cylindrical lens has been problematic, because the distributed line pattern typically has a height taller than that desired, does not have sharp edges, is dominated by optical aberrations, and is nonuniform in intensity since the light intensity is brightest along an optical axis on which the LED is centered, and then falls off away from the axis, especially at opposite end regions of the distributed line pattern. Also, the coupling efficiency between the LED and the cylindrical lens has been poor. Adding an aperture stop between the LED and the cylindrical lens will improve the sharpness (i.e., shorten the height) of the distributed line pattern, but at the cost of a poorer coupling efficiency and a dimmer distributed line pattern that, of Course, degrades reading performance.

In addition, the use of an imaging reader has been frustrated, because an operator cannot tell whether the imager, or the reader in which the imager is mounted, is aimed directly at the target symbol, which can be located anywhere within a range of working distances from the reader. The imager is a passive unit and provides no visual feedback to the operator to advise where the imager is aimed. To alleviate such problems, the prior art has proposed an aiming light assembly for an imaging reader. The known aiming light assembly utilizes an aiming light source for generating an aiming beam and an aiming lens for focusing the aiming beam as a visible aiming light line or pattern on the symbol prior to reading. The above-described illuminating light assembly can also serve as the aiming light assembly, in which case, the aiming pattern will suffer the same disadvantages described above for the distributed line pattern.

### SUMMARY OF THE INVENTION

One feature of the present invention resides, briefly stated, in a module or an arrangement for generating a generally uniform distributed line pattern of light on a symbol to be read by image capture. The module or arrangement includes a light source for generating light along an optical axis in a light distribution having different extents along intersecting directions, e.g., the horizontal and vertical directions, generally perpendicular to the axis.

In one embodiment, the light source is an aiming light source for generating an aiming light pattern on the symbol. In another embodiment, the light source is an illumination light source for illuminating the symbol with an illumination light pattern. In either or both embodiments, the light source is a plurality of light emitting diode (LED) chips, each sized in the micron range and serving essentially as point sources, spaced apart from one another along the horizontal direction. Alternatively, the light source is a single, horizontally elongated, linear LED chip in a casing having a narrow vertical slit or opening. In either alternative, the light distribution is wide or long along the horizontal direction and extends lengthwise across and past the symbol, and is short and narrow along the vertical direction and extends for a small limited distance heightwise of the symbol.

The module or arrangement further includes a linear lens array having a plurality of compound curvature lenses spaced apart from one another along one of said directions, e.g., the horizontal direction, for receiving the light from the light source, and for optically modifying the light from the light source to generate the generally uniform distributed line pattern of light on the symbol. Each lens has a concave curvature, preferably an aspheric toroid, for diverging the light along said one horizontal direction that extends lengthwise along the symbol, and a convex curvature, again preferably an aspheric toroid, for collimating the light along the other of said directions, e.g., the vertical direction, that extends for a short, narrow, limited distance along a height of the symbol. The lenses are commonly molded of a one-piece construction, preferably of a light-transmissive plastic material. The one-piece construction advantageously has tapered end and side walls diverging apart from each other in a direction away from the light source to resist internal reflections within the linear lens array.

The module or arrangement still further includes a solid-state imager, such as a CCD or a CMOS, having an array of image sensors for capturing return light from the symbol over a field of view having different extents along the intersecting horizontal and vertical directions. The array is one-dimensional, i.e., linear, or is two-dimensional with an anamorphic field of view. The field of view of the imager generally matches the distributed line pattern of light on the symbol.

Each LED chip emits light, typically with a Lambertian intensity profile in which the intensity falls off along the horizontal direction as a function of the cosine angle. Hence, the LED chips are preferably spaced apart such that their intensity profiles overlap, thereby creating a more uniform intensity distribution along the horizontal direction. Since light emitted by one chip could interfere with light emitted by an adjacent chip, a baffle is preferably located between adjacent LED chips for resisting optical crosstalk that would otherwise corrupt the uniformity of the distributed line pattern. The baffles could also serve as an alignment aid when positioning the linear lens array relative to the light source.

One additional feature of the present invention resides in first coupling the LED chips to dome-shaped field lenses to reduce the conical angle of the emitted light prior to reaching the linear lens array. This feature will increase the light throughput. The LED chips could also be coupled to an array of parabolic reflective concentrators, again to constrain the conical angle and to increase the light throughput. The concentrators could also serve as the aforementioned baffles.

Yet another feature of the present invention resides in configuring the LED chips to emit light of different colors. For example, one group of the chips could emit green light which is more visible to a human eye, and thus is especially useful when the distributed line pattern is used as an aiming pattern; and another group of the chips could emit red light which is more visible to the imager due to increased sensitivity to red light, and thus is especially useful when the distributed line pattern is used as an illuminating pattern.

For a more integrated construction, a centrally located LED chip could be replaced with the imager, in which case, the associated lens on the linear lens array would either be replaced by an aperture, or with an imaging lens operative to project captured light onto the imager.

In accordance with this invention, the compound curvature lenses form the distributed line pattern as wide and short with sharp edges and as not dominated by optical aberrations. The intensity of the distributed line pattern is uniform with much less fall off away from the axis at opposite end regions of the distributed line pattern. Also, the coupling efficiency between the elongated light source and the elongated linear lens array is much improved, thereby increasing light throughput and enhancing reading performance.

The method of generating a generally uniform distributed line pattern of light on a symbol to be read by image capture is performed by generating light emitted from a light source along an optical axis in a distribution having different extents along intersecting directions generally perpendicular to the axis, spacing a plurality of compound curvature lenses apart from one another along one of said directions to form a linear lens array for receiving the light from the light source, and for optically modifying the light from the light source to generate the generally uniform distributed line pattern of light on the symbol, configuring each lens with a concave curvature for diverging the light along said one direction, configuring each lens with a convex curvature for collimating the light along the other of said directions, and capturing return light from the symbol with an array of image sensors of a solid-state imager over a field of view having different extents along the intersecting directions.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a portable imaging reader operative in either a handheld mode, or a hands-free mode, for capturing return light from target symbols;

FIG. 2 is a schematic diagram of various components of the reader of FIG. 1;

FIG. 3 is a side elevational view of the aiming light system and/or the illumination light system of FIG. 2 in accordance with the present invention;

FIG. 4 is a top plan view of the systems of FIG. 3;

FIG. 5 is a view analogous to FIG. 4 depicting use of a microlens array; and

FIG. 6 is a perspective view of another embodiment of a light source for use with the invention.

### DETAILED DESCRIPTION OF THE PREFERRED EMBODIMENTS

Reference numeral 30 in FIG. 1 generally identifies an imaging reader having a generally vertical window 26 and a gun-shaped housing 28 supported by a base 32 for supporting the imaging reader 30 on a countertop. The imaging reader 30 can thus be used in a hands-free mode as a stationary workstation in which products are slid, swiped past, or presented to, the vertical window 26, or can be picked up off the countertop and held in an operator's hand and used in a handheld mode in which a trigger 34 is manually depressed to initiate imaging of indicia, especially one-dimensional symbols, to be read at far distances from the window 26. In another variation, the base 32 can be omitted, and housings of other configurations can be employed. A cable, as illustrated in FIG. 1, connected to the base 32 can also be omitted, in which case, the reader 30 communicates with a remote host by a wireless link, and the reader is electrically powered by an on-board battery.

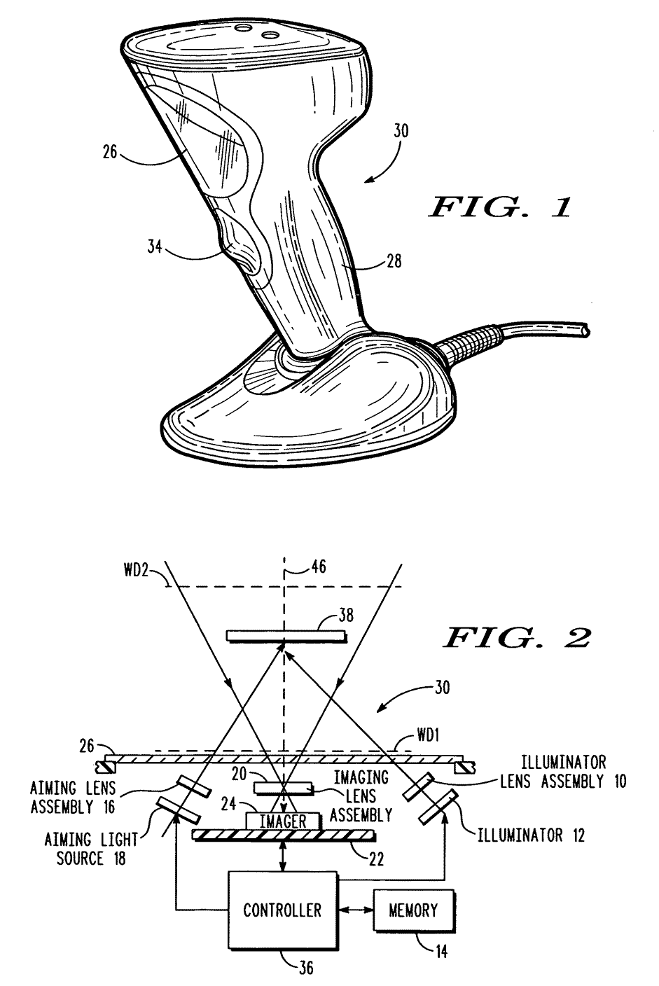

As schematically shown in FIG. 2, an imager 24 is mounted on a printed circuit board 22 in the reader. The imager 24 is a solid-state device, for example, a CCD or a CMOS imager having a one-dimensional array of addressable image sensors or pixels arranged in a single, linear row, or a two-dimensional array of such sensors arranged in mutually orthogonal rows and columns, preferably with an anamorphic field of view, and operative for detecting return light captured by an imaging lens assembly 20 along an optical path or axis 46 through the window 26. The return light is scattered and/or reflected from a target or symbol 38 over the field of view. The imaging lens assembly 20 is operative for adjustably focusing the return light onto the array of image sensors to enable the symbol 38 to be read. The symbol 38 is located anywhere in a working range of distances between a close-in working distance (WD1) and a far-out working distance (WD2). In a preferred embodiment, WD1 is about four to six inches from the imager array 24, and WD2 can be many feet from the window 26, for example, around fifty feet away.

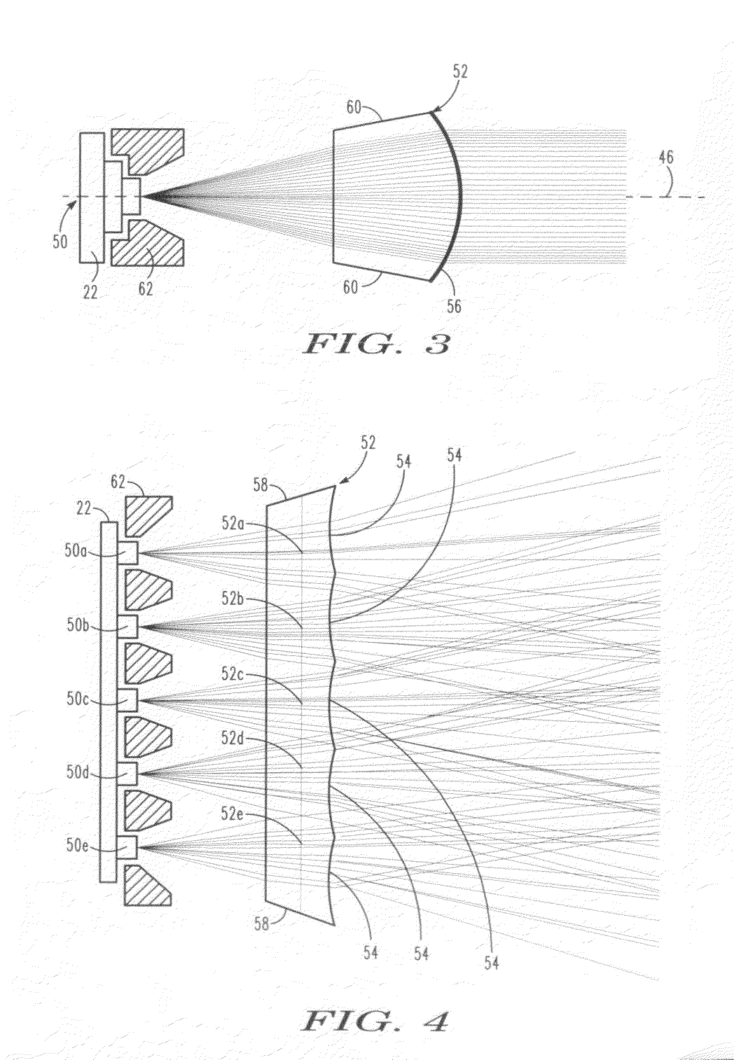

An illuminating assembly is also mounted in the imaging reader and preferably includes an illuminator or illuminating light source 12, e.g., a light emitting diode (LED), and an illuminating lens assembly 10 to uniformly illuminate the symbol 38 with an illuminating light pattern. Details of the illuminating assembly, as best seen in FIGS. 3-4, are described below.

An aiming assembly is also mounted in the imaging reader and preferably includes an aiming light source 18, e.g., an LED, and an aiming lens assembly 16 for generating an aiming light pattern on the symbol 38. Details of the aiming assembly, as also best seen in FIGS. 3-4, are described below.

As shown in FIG. 2, the imager 24, the illuminating light source 12 and the aiming light source 18 are operatively connected to a controller or microprocessor 36 operative for controlling the operation of these components. A memory 14 is connected and accessible to the controller 36. Preferably, the microprocessor is the same as the one used for processing the return light from target symbols and for decoding the captured target images.

In operation, the microprocessor 36 sends a command signal to energize the aiming light source 18 prior to reading, and also pulses the illuminating light source 12 for a short exposure time period, say 500 microseconds or less, and energizes and exposes the imager 24 to collect light, e.g., illumination light and/or ambient light, from a target symbol only during said exposure time period. A typical array needs about 33 milliseconds to acquire the entire target image and operates at a frame rate of about 30 frames per second.

One feature of the present invention resides, briefly stated, in a module or an arrangement for, and a method of, generating a generally uniform distributed line pattern of light on the symbol 38 to be read by image capture. The module or arrangement includes a light source 50, as shown in FIG. 3, for generating light along the optical axis 46 in a light distribution having different extents along intersecting directions, e.g., the horizontal and vertical directions, generally perpendicular to the axis 46. FIG. 3 depicts the light distribution along the vertical direction, and FIG. 4 depicts the light distribution along the horizontal direction.

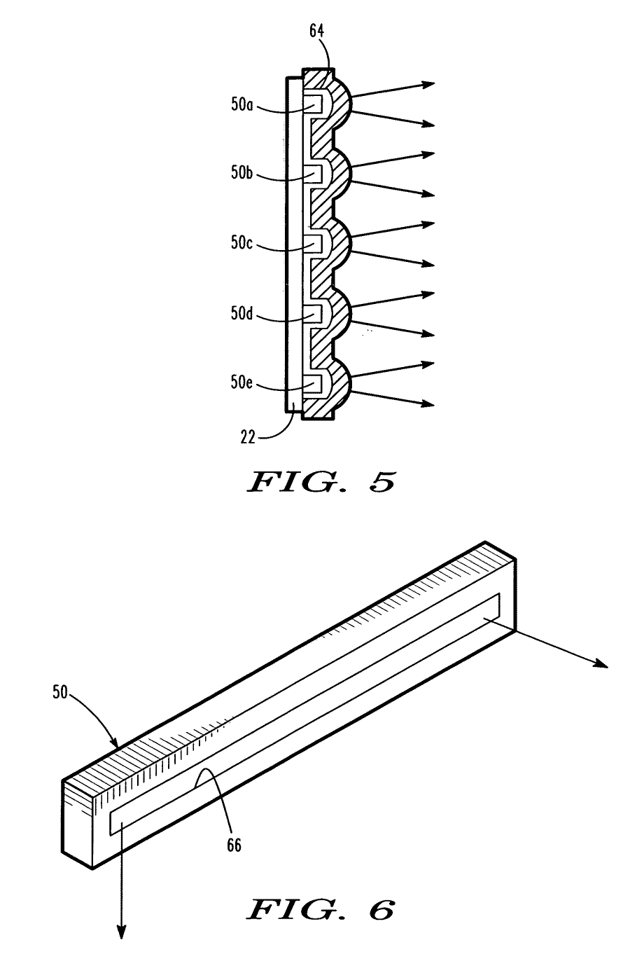

In one embodiment, the light source 50 is the aiming light source 18 for generating the aforementioned aiming light pattern on the symbol 38. In another embodiment, the light source 50 is the illumination light source 12 for illuminating the symbol 38 with the aforementioned illumination light pattern. In either or both embodiments, the light source 50, as shown in FIG. 4, is a plurality of light emitting diode (LED) chips 50a, 50b, 50c, 50d, 50e, each sized in the micron range and serving essentially as point sources, spaced apart from one another along the horizontal direction. Although five chips have been illustrated, this is merely exemplary, because more or less than five chips could be employed. Alternatively, the light source 50, as shown in FIG. 6, can be configured as a single, horizontally elongated, linear LED chip in a casing having a narrow vertical slit or opening 66. In either alternative, the light distribution is wide or long along the horizontal direction and extends lengthwise across and past the symbol 38, and is short and narrow along the vertical direction and extends for a small limited distance heightwise of the symbol 38.

The module or arrangement further includes a linear lens array 52, as shown in FIG. 3, having a plurality of compound curvature lenses 52a, 52b, 52c, 52d, 52e, as shown in FIG. 4, spaced apart from one another along one of said directions, e.g., the horizontal direction, for respectively receiving the light from the associated LED chips 50a, 50b, 50c, 50d, 50e, and for optically modifying the light from the associated LED chips 50a, 50b, 50c, 50d, 50e to generate the generally uniform distributed line pattern of light on the symbol 38. The linear lens array 52 serves as the illuminator lens assembly 10 and/or as the aiming lens assembly 16. Each lens 52a, 52b, 52c, 52d, 52e has a concave curvature 54, preferably an aspheric toroid, for diverging the light along said one horizontal direction that extends lengthwise along the symbol 38, and a convex curvature 56, again preferably an aspheric toroid, for collimating the light along the other of said directions, e.g., the vertical direction, that extends for a short, narrow, limited distance along a height of the symbol 38. The lenses 52a, 52b, 52c, 52d, 52e are commonly molded of a one-piece construction, preferably of a light-transmissive plastic material. The one-piece construction advantageously has tapered end walls 58 and side walls 60 diverging apart from each other in a direction away from the light source to resist internal reflections within the linear lens array 52.

As previously noted, the imager 24 captures the return light front the symbol 38 over a field of view having different extents along the intersecting horizontal and vertical directions. The field of view of the imager 24 generally matches the distributed line pattern of light on the symbol 38.

Each LED chip 50a, 50b, 50c, 50d, 50e emits light, typically with a Lambertian intensity profile in which the intensity falls off along the horizontal direction as a function of the cosine angle. Hence, the LED chips are preferably spaced apart such that their intensity profiles overlap, thereby creating a more uniform intensity distribution along the horizontal direction. Since light emitted by one chip could interfere with light emitted by an adjacent chip, a light-obstructing baffle 62 has blocking portions preferably located between adjacent LED chips for resisting optical crosstalk that would otherwise corrupt the uniformity of the distributed line pattern. The baffle has a plurality of tapered openings each sized to match the numerical aperture of the linear lens array 52. The baffle 62 could also serve as an alignment aid when positioning the linear lens array relative to the light source. End baffles could also be employed.

One additional feature of the present invention resides in first coupling the LED chips to a microlens array 54, as shown in FIG. 5, having dome-shaped field lenses to reduce the conical angle of the emitted light prior to reaching the linear lens array 52. This feature will increase the light throughput. The LED chips could also be coupled to an array of parabolic reflective concentrators, again to constrain the conical angle and to increase the light throughput. The concentrators could also serve as the aforementioned baffles 62.

Yet another feature of the present invention resides in configuring the LED chips to emit light of different colors. For example, one group of the chips, e.g., 50a and 50e, could emit green light which is more visible to a human eye, and thus is especially useful when the distributed line pattern is used as an aiming pattern; and another group of the chips, e.g., 50b and 50d, could emit red light which is more visible to the imager 24 due to increased sensitivity to red light, and thus is especially useful when the distributed line pattern is used as an illuminating pattern.

For a more integrated construction, a centrally located LED chip, e.g., 50c, could be replaced with the imager 24, in which case, the associated lens 52c on the linear lens array 52 would either be replaced by an aperture, or with the imaging lens 20 operative to project captured light onto the imager 24. The chips, the baffles and the imager are preferably commonly mounted on the board 22.

In accordance with this invention, the compound curvature lenses 52a, 52b, 52c, 52d, 52e form the distributed line pattern as wide and short with sharp edges and as not dominated by optical aberrations. The intensity of the distributed line pattern is uniform with much less fall off away from the axis 46 at opposite end regions of the distributed line pattern. Also, the coupling efficiency between the elongated light source 50 and the elongated linear lens array 52 is much improved, thereby increasing light throughput and enhancing reading performance.

It will be understood that each of the elements described above, or two or more together, also may find a useful application in other types of constructions differing from the types described above. For example, higher order aspherical terms could be provided in the concave curvatures 54 at the ends of the linear lens array 52 in order to send more light to the opposite end regions of the distributed line pattern.

While the invention has been illustrated and described as an arrangement or module for, and a method of, generating a generally uniform distributed line pattern of light on a symbol to be read by image capture by an imaging reader, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. An arrangement for generating a generally uniform distributed line pattern of light on a symbol to be read by image capture, comprising:
a light source for generating light along an optical axis in a distribution having different extents along intersecting directions generally perpendicular to the axis;
a linear lens array having a plurality of compound curvature lenses spaced apart from one another along one of said directions, for receiving the light from the light source, and for optically modifying the light from the light source to generate the generally uniform distributed line pattern of light on the symbol, each lens having a concave curvature for diverging the light along said one direction, and a convex curvature for collimating the light along the other of said directions; and
a solid-state imager having an array of image sensors for capturing return light from the symbol over a field of view having different extents along the intersecting directions.

2. The arrangement of claim 1, wherein the light source is one of an aiming light source for generating an aiming light pattern on the symbol and an illumination light source for illuminating the symbol with an illumination light pattern.

3. The arrangement of claim 1, wherein the light source is a plurality of light emitting diode (LED) chips spaced apart from one another along said one direction.

4. The arrangement of claim 3, and a baffle having a plurality of baffle portions, each being located between a pair of adjacent LED chips, for resisting light emitted by one chip of the pair from interfering with light emitted by the adjacent chip of the pair.

5. The arrangement of claim 3, wherein the LED chips emit light of different colors.

6. The arrangement of claim 1, wherein the convex curvature of each lens is an aspheric toroid.

7. The arrangement of claim 1, wherein the concave curvature of each lens is an aspheric toroid.

8. The arrangement of claim 1, wherein the lenses are molded of a one-piece construction having tapered walls diverging apart from each other in a direction away from the light source.

9. The arrangement of claim 1, wherein the light source is a single elongated light emitting diode (LED) chip extending along said one direction.

10. The arrangement of claim 1, and a plurality of dome-shaped lenses between the light source and the linear lens array, the dome-shaped lenses being spaced apart from one another along said one direction.

11. An imaging reader for electro-optically reading a symbol by image capture, comprising:
a housing; and
an imaging module supported by the housing, the module including a light source for generating light along an optical axis in a distribution having different extents along intersecting directions generally perpendicular to the axis, a linear lens array having a plurality of compound curvature lenses spaced apart from one another along one of said directions, for receiving the light from the light source, and for optically modifying the light from the light source to generate a generally uniform distributed line pattern of light on the symbol, each lens having a concave curvature for diverging the light along said one direction, and a convex curvature for collimating the light along the other of said directions, and a solid-state imager having an array of image sensors for capturing return light from the symbol over a field of view having different extents along the intersecting directions.

12. A method of generating a generally uniform distributed line pattern of light on a symbol to be read by image capture, comprising the steps of:
generating light emitted from a light source along an optical axis in a distribution having different extents along intersecting directions generally perpendicular to the axis;
spacing a plurality of compound curvature lenses apart from one another along one of said directions to form a linear lens array for receiving the light from the light source, and for optically modifying the light from the light source to generate the generally uniform distributed line pattern of light on the symbol;
configuring each lens with a concave curvature for diverging the light along said one direction, and configuring each lens with a convex curvature for collimating the light along the other of said directions; and
capturing return light from the symbol with an array of image sensors of a solid-state imager over a field of view having different extents along the intersecting directions.

13. The method of claim 12, and configuring the light source as one of an aiming light source for generating an aiming light pattern on the symbol and an illumination light source for illuminating the symbol with an illumination light pattern.

14. The method of claim 12, and configuring the light source as a plurality of light emitting diode (LED) chips spaced apart from one another along said one direction.

15. The method of claim 14, and locating a plurality of baffle portions each between a pair of adjacent LED chips for resisting light emitted by one chip of the pair from interfering with light emitted by the adjacent chip of the pair.

16. The method of claim 14, and configuring the LED chips to emit light of different colors.

17. The method of claim 12, and configuring at least one of the convex curvature and the concave curvature of each lens as an aspheric toroid.

18. The method of claim 12, and molding the lenses of a one-piece construction with tapered walls that diverge apart from each other in a direction away from the light source.

19. The method of claim 12, and configuring the light source as a single elongated light emitting diode (LED) chip extending along said one direction.

20. The method of claim 12, and locating a plurality of dome-shaped lenses between the light source and the linear lens array, and spacing the dome-shaped lenses apart from one another along said one direction.
